(19) United States
(12) Patent Application Publication
(10) Pub. No.: US 2009/0235774 A1
(43) Pub. Date: Sep. 24, 2009

(54) CASING SYSTEM FOR PROTECTING A CABLE

(76) Inventor: Yuan-Hung Wen, Taichung City (TW)

Correspondence Address: Chien-Hui Su, P. O. Box 70-121 Taichung, Taichung City, 40899, TW

(21) Appl. No.: 12/050,959

(22) Filed: Mar. 19, 2008

(51) Int. Cl. F16C 1/26

(52) U.S. Cl. 74/502.6

(57) ABSTRACT

A casing system for protecting a cable, the casing having a first end and a second end, an inner diameter of a recess being equal to or greater than an outer diameter of the second end, a groove positioning in the recess, a passageway penetrating through the groove to the second end of the casing; a washer installing in the groove and having a passing hole for communicating the passageway, an inner diameter of the passing hole being less than an inner diameter of the passageway; wherein, the casing can provide protective effect for a cable.

### FIELD OF THE INVENTION

The present invention relates to a casing system, particularly to a casing with a washer inside for gripping the cable and omitting the plastic tube around the cable.

### BACKGROUND OF THE INVENTION

For riding bicycle, brake cable is very important; in the past, brake cable are exposed outside of the bicycle that be drenched and shined every day, even the steel brake cable also gets rusty, so the manufacturer usually using a flexible plastic tube covering around the cable for attaining protective effect, and flexible plastic tube can be bent different radian for satisfying the bicycle.

However, the plastic tube will lose the bounce to be brittle and easily peel off for a long time using, that moment, the plastic tube will be broken and fail to protect the brake cable anymore, especially when the brake cable be bent with different radian, the cable will be exposed out of the plastic tube, that dust will influence the acting of the brake cable; moreover, it is fixed when the plastic tube is cut for covering around the brake cable, and the plastic tube can't make any adjustment if the length of the brake cable is need to be adjusted.

U.S. Pat. No. 6,250,175 provides an improvement that includes a cable for transmitting a tensile force, a flexible tube for accommodating the cable, and a casing surrounding the tube for absorbing a pressure force. The casing is composed of a plurality of form-parts so joined to one another as to form a continuous axial passageway which is defined by an inside dimension. The form-parts are so configured that abutting end faces between successive form-parts have a complementary configuration to thereby enable a disposition of the casing along an arcuate path, with the tube being defined by an outside dimension corresponding to the inside dimension of the passageway.

But, the outer of the cable of those prior arts still covers the flex tube for avoiding the cable contacting with the casing that influences the acting of the cable, the flexible tube will be brittle and peel off inside of the casing, that the peel of flexible tube will stuck the casing and blocking the pull movement of the cable. Furthermore the flexible tube is usually made with plastic in addition to cover the cable, it's cost a lot for manufacturing. And the prior art just has different caliber of two end of the casing for joining to one another, it is very easy to loose and it couldn't provide stably connecting effect for joining one to each other. Thus there is an eager demand for a novel design which can improve the defect in the prior art.

### SUMMARY OF THE INVENTION

Accordingly, the primary object of the present invention is to provide better structure for connecting and wider angle for bending, and the present invention can avoid the plastic tube covering around the cable.

To achieve the above objectives, the present invention provides a casing system for protecting a cable, the casing having a first end and a second end comprising: a recess positioning inside the first end, an inner diameter of the recess being equal to or greater than an outer diameter of the second end, a groove positioning in the recess, a passageway penetrating through the groove to the second end of the casing for communicating the first end and the second end. A washer installing in the groove and having a passing hole for communicating the passageway, an inner diameter of the passing hole being less than an inner diameter of the passageway; and wherein the second end of the casing assembles into the recess of the first end of another casing for joining plurality of the casing to form a continuous casing system for admitting a cable, the passing hole of the washer grips the cable for protecting the cable.

The second end is corresponding to the inside surface of the first end with curve shape, when the second end of casing assembles into the recess of the first end of another casing, the second end of the casing has a wider angle for pivoting to cooperate the cable. The trumpet shape of the passageway provides less limitation for bending the casing system and diminishing the friction between casing and cable. Moreover the shape of outside surface of the second end is corresponding to the shape of inside surface of the recess for strengthening the connecting structure, it provides stronger and more stable structure for connecting. Furthermore the flexible washer grips the cable for avoiding the cable contacting the casing, it don't need to cover a flexible plastic tube around the cable additionally, the cable still can work for transmitting a tensile force as usual. The casing of invention can protect the cable well.

The various objectives and advantages of the present invention will be more readily understood from the following detailed description when read in conjunction with the appended drawing.

### BRIEF DESCRIPTION OF THE DRAWINGS

FIGS. 1 is a cutaway view of the first embodiment of the present invention.

FIGS. 2 is a general, sectional perspective view of the first embodiment of the present invention.

FIGS. 3 shows the operation and cross-sectional view of the first embodiment of the present invention.

FIGS. 4 is a operation, sectional perspective view of the first embodiment of the present invention.

FIGS. 5 is a cutaway view of the second embodiment of the present invention.

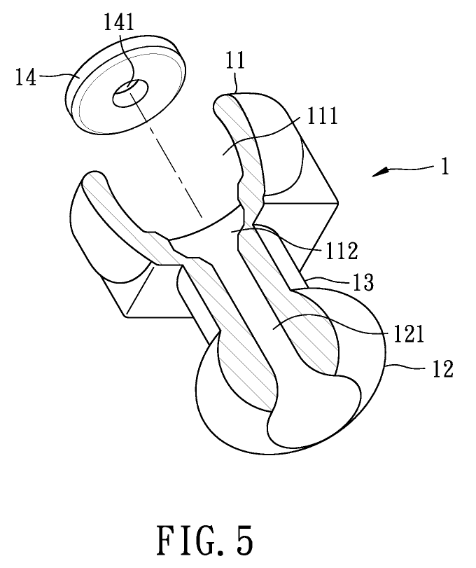

### DETAILED DESCRIPTION OF THE INVENTION

In order that those skilled in the art can further understand the present invention, a description will be provided in details below. However, these descriptions and the appended drawings are only used for those skilled in the art to understand the objects, features, and characteristics of the present invention, but not to be used to confine the scope and spirit of the present invention defined in the appended claims.

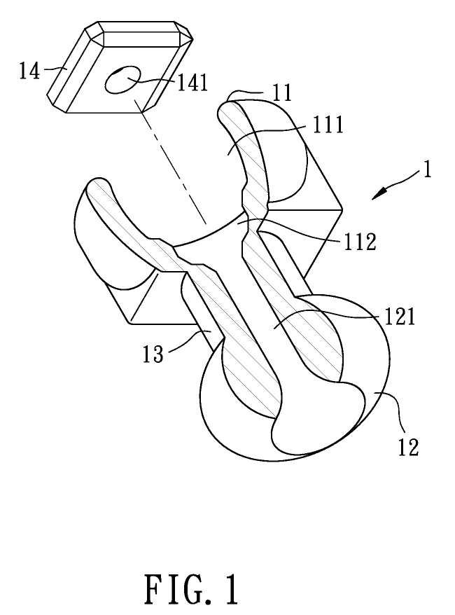

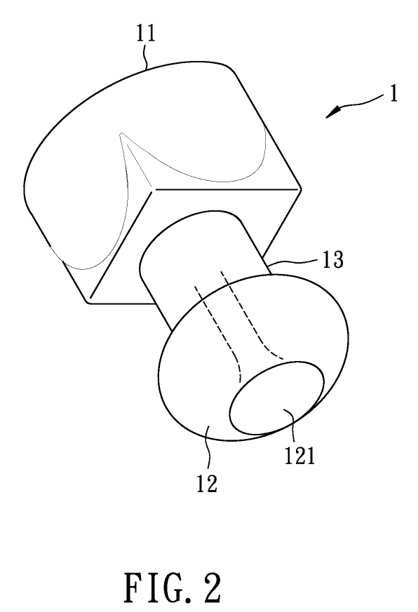

Referring the first embodiment of FIG. 1 to FIG. 4, the casing 1 system for protecting cable according to the present invention is illustrated.

The casing 1 of the present invention has the following elements:

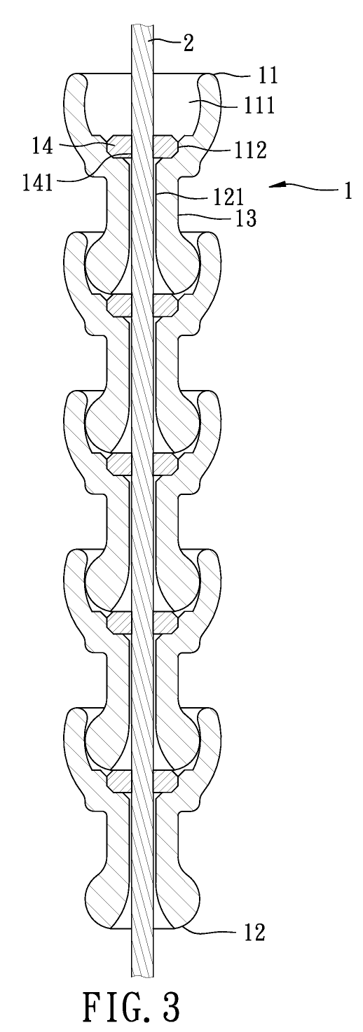

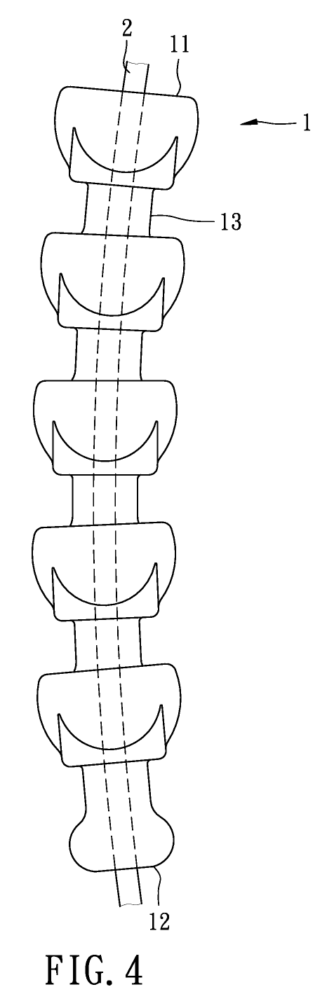

two end of the casing 1 are defined a first end 11 and a second end 12. An outer diameter of the first end 11 is greater than an outer diameter of the second end 12. An annular portion 13 is positioned between the first end 11 and the second end 12, an outer diameter of the annular portion 13 is less than the outer diameter of the first end 11 and the second end 12. A recess 111 axial positions inside the first end 11; the inside surface of the recess 111 is in a shape of concave curve, the shape of outside surface of the second end 12 corresponds to the inside surface of the recess 111 to be formed of a curve shape. An inner diameter of the recess 111 is equal to or greater than a maximum outer diameter of the second end 12, so the second end 12 of the casing 1 can plug into the recess 111 of the first end 11 of another casing 1; a groove 112 axial positions in the bottom of the recess 111; a flexible washer 14 is in a shape of quadrate of the first embodiment installing in the groove 112, the groove 112 corresponds to the washer 14 to be formed of a quadrate shape; a passing hole 141 goes through to the center of the washer 14; a passageway 121 axial penetrates through the bottom of the groove 112 to the second end 12 for communicating the first end 11 and the second end 12. An inner diameter of the passageway 121 nearby the recess 111 is less than an inner diameter of the passageway 121 nearby the second end 12 to be formed of trumpet shape. The passing hole of the washer 14 communicates the passageway 121, an inner diameter of the passing hole 141 is less than the inner diameter of the passageway 121; and

wherein, as FIG. 3 and FIG. 4 shows, the second end 12 of the casing 1 can plug into the recess 111 of the first end 11 of another casing 1 for joining plurality of casing 1, so the plurality of casing 1 are formed of a continuous casing 1 system for assembling into a cable 2. Because of the second end 12 corresponds to the inside surface of the first end 11 with curve shape, when the second end 12 of casing 1 plugs into the recess 111 of the first end 11 of another casing 1, the second end 12 of the casing 1 has a wider angle for pivoting to cooperate the cable 2; and

the flexible washer 14 installs in the groove 112 having a passing hole 141. Otherwise, the inner diameter of the passing hole 141 is less than the diameter of the cable 2, the cable 2 is pressed into the passing hole 141 of the washer 14, so the washer 14 grips the cable 2 for avoiding the cable 2 contacting the casing 1. In that, it don't need to cover a flexible plastic casing 1 around the cable 2 additionally, the cable 2 still can act for transmitting a tensile force as usual, the casing 1 of invention can protect the cable 2 well.

FIG. 6 shows the second embodiment, the washer 14 is in a shape of quadrate, and the grooves 112 corresponds to the washer 14 is formed of a quadrate shape.

However, above mentioned embodiments are just examples of the present invention, they are not confined the scope of the present invention. The forms of the handle and head and the location of the slot may be varied as desired.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A casing system for protecting a cable, said casing having a first end and a second end comprising:
a recess positioning inside the first end, an inner diameter of the recess being equal to or greater than an outer diameter of the second end, a groove positioning in the recess, a passageway penetrating through the groove to the second end of the casing for communicating the first end and the second end;
a washer installing in the groove and having a passing hole for communicating the passageway, an inner diameter of the passing hole being less than an inner diameter of the passageway; and
wherein the second end of the casing assembles into the recess of the first end of another casing for joining plurality of the casing to form a continuous casing system for admitting a cable, the passing hole of the washer grips the cable for protecting the cable.

2. The casing system for protecting a cable as claimed in claim 1, wherein the washer is flexible.

3. The casing system for protecting a cable as claimed in claim 1, wherein the washer is in a shape of quadrate or circular.

4. The casing system for protecting a cable as claimed in claim 1, wherein an inner diameter of the passageway nearby the recess is less than an inner diameter of the passageway nearby the second end.

5. The casing system for protecting a cable as claimed in claim 1, wherein the inside surface of the recess is in a shape of concave curve.

6. The casing system for protecting a cable as claimed in claim 1, wherein the outside surface of the second end of the casing is in a shape of convex curve.

7. The casing system for protecting a cable as claimed in claim 1, wherein an annular portion is positioned in between the first end and the second end of the casing, an outer diameter of the annular portion is less than an outer diameter of the second end.
